(19) United States
(12) Patent Application Publication
(10) Pub. No.: US 2026/0170417 A1
(43) Pub. Date: Jun. 18, 2026

(54) CLASSIFIER ENSEMBLE MODEL SYSTEM FOR MULTI-LABEL CLASSIFICATION

(71) Applicant: Optum, Inc., Minnetonka, MN (US)

(72) Inventors: Pawan Sharma, New Delhi (IN); Vipin Sagi, Hyderabad (IN)

(21) Appl. No.: 18/986,121

(22) Filed: Dec. 18, 2024

(51) Int. Cl. G06N 20/20; G06F 40/20

(52) U.S. Cl. CPC G06N 20/20; G06F 40/20

(57) ABSTRACT

Various embodiments of the present disclosure provide a data feature engineering technique that improves the functionality of a computer in various aspects. The techniques comprise receiving an unclassified data object representative of an incident associated with a software system; generating a domain-enhanced data object based on the unclassified data object and a domain that is associated with the software system; generating an enhanced entity-level vector for a pre-processed unclassified entity from the domain-enhanced data object by combining a weighted frequency measure vector with an entity-level vector for the pre-processed unclassified entity; generating an incident representation vector for the domain-enhanced data object based on the enhanced entity-level vector; and providing the incident representation vector as input to a classifier ensemble model to receive a set of classification outputs that respectively corresponds to a set of incident attribute labels for the incident.

### BACKGROUND

Various embodiments of the present disclosure address technical challenges related to data feature extraction and classification, particularly of unclassified data objects comprising plain and/or unstructured natural language descriptions of software-related incidents. An incident management system may classify user-provided incident descriptions and manage actions associated with handling and/or resolving software-related incidents. As such, maintaining system stability and efficiency of software systems may depend on effective, accurate, and/or consistent classification of the user-provided incident descriptions. However, classification of user-provided incident descriptions is hindered by several technical challenges, such as incidents that (i) are described in plain and/or unstructured natural language, (ii) span multiple domains and/or systems, (iii) depend on domain-specific knowledge to properly classify, and/or (iv) may be classified along multiple dimensions simultaneously. For example, traditional approaches often fail to capture the nuanced relationships between user-provided descriptions of incidents and their various attributes, leading to inconsistent classification and suboptimal incident tracking within a computer environment.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram showing example hardware and/or software components for processing and/or generating predictions for descriptions of software-related incidents in accordance with some embodiments of the present disclosure.

FIG. 5 depicts an operational example of a data processing pipeline in accordance with some embodiments of the present disclosure.

FIG. 6 depicts an operational example of generating a representation vector in accordance with some embodiments of the present disclosure.

FIG. 7 depicts a flowchart diagram of an example machine learning inference process in accordance with some embodiments of the present disclosure.

FIG. 8 depicts a flowchart diagram of an example data feature engineering process in accordance with some embodiments of the present disclosure.

### DETAILED DESCRIPTION

Various embodiments of the present disclosure provide feature engineering and downstream machine learning ensemble architectures that that improve machine learning based classification tasks by addressing various technical challenges with natural language processing (NLP). More particularly, some embodiments of the present disclosure provide a feature engineering framework that first enhances a data object to with a set of domain specific features extracted and applied to the data object through a series of preprocessing techniques specifically designed for a classification domain. Then, using the enhanced features of the domain-enhanced data object, some embodiments of the present disclosure covert the data object to an incident representation vector that combines domain-specific features with domain-agnostic features into a single vector representation. The single vector representation may thereafter serve as an information dense representation of the data object that may improve the performance of downstream classifiers models and, in some embodiments, enable to integration of a series of classifiers into a classifier ensemble capable of generating a comprehensive set of domain-specific predictions from a single input, the incident representation vector. In this way, some embodiments of the present disclosure may combine preprocessing techniques, domain-specific knowledge integration, and a classifier ensemble model to improve the accuracy, speed, and scalability of traditional machine learning based classification approaches, such as those traditionally used for description classification and/or incident management in complex domain, such as software environments.

Some embodiments of the present disclosure provide a classifier ensemble model that leverages a set of machine learning classifier models to generate improved predictions with respect to a plurality of features vectorized within an incident representation vector. For example, to overcome performance deficiencies with traditional classification approaches, a feature engineering pipeline may be employed to generate representation vectors that are provided to the classifier ensemble model. The feature engineering pipeline may be used to transform an unclassified data object (e.g., that comprises a description of an incident associated with a software system) to a representation vector by applying domain processing techniques, NLP techniques, and/or weighted frequency measure vectors. By doing so, the classifier ensemble model may be better able to generate improved predictions with respect to comprehensiveness, accuracy, and/or correctness over traditionally underperforming classification models. This, in turn, enables improved predictions that, unlike traditional techniques, may handle descriptions of a range of complexities without reductions in classification accuracy, thereby improving the performance of incident management systems processing such descriptions. Accordingly, the data processing pipeline and classifier ensemble model of the present disclosure provides improved classification and/or prediction of plain and/or unstructured natural language descriptions over traditional classification models.

The present disclosure provides a computer-implemented method for analyzing and classifying incident descriptions in software systems using machine learning techniques. The disclosed method may enhance incident description classification by utilizing a specific arrangement of domain-specific knowledge, NLP, and a classifier ensemble model. In some embodiments, an unclassified data object is processed via a domain rule engine and NLP operations to generate enhanced entity-level vectors that may be provided as a representation vector to a classifier ensemble model. The classifier ensemble model may comprise multiple machine learning classifiers that are used to generate a set of attribute labels for the representation vector. As such, the disclosed method enables more accurate and efficient classification of descriptions (e.g., software-related incidents) by engineering input to downstream machine learning models through advanced machine learning and feature engineering techniques.

Examples of technologically advantageous embodiments of the present disclosure comprise (i) modifications to conventional feature engineering techniques that enhance feature representations to improve downstream machine learning operation, (ii) a particular method for applying the enhance feature representations to improve both training and inference of operations of downstream models, (iii) a distribution of functionality provided by a classifier ensemble model to filter network content in a messaging system, such as an incident management system, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

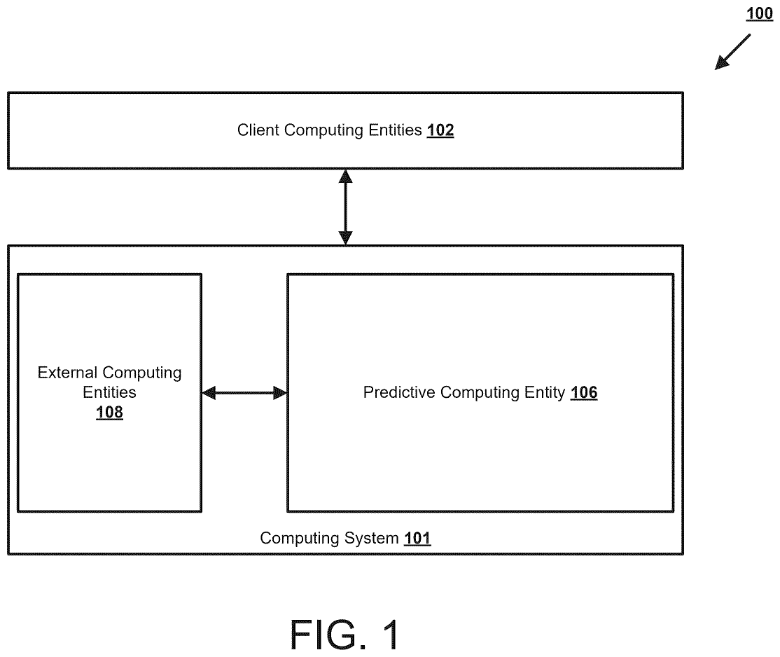

FIG. 1 depicts a block diagram of an example architecture 100 in accordance with some embodiments of the present disclosure. The architecture 100 comprises a computing system 101 configured to receive a request (e.g., comprising a plain and/or unstructured natural language description of a software system incident), such as a machine learning model prompt request, and/or the like, from client computing entities 102, process the request (e.g., generate classifications or predictions and/or perform prediction-based actions), and provide responses (e.g., recommendations, messages, and/or alerts) to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learning models may be trained to generate candidate outputs, candidate output scores, and/or other machine learned outputs in response to a request received from the client computing entities 102. The machine learning models may be adapted to a rules-based engine, NLP operations logic, and/or a weighted frequency measure vector mechanism that may collectively process a request using a classifier ensemble model.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive a request (e.g., comprising a plain and/or unstructured natural language description of a software system incident), such as a machine learning model prompt request, and/or the like, from client computing entities 102, process the request (e.g., generate classifications or predictions and/or perform prediction-based actions), and provide responses (e.g., recommendations, messages, and/or alerts) to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., domain enhancement, pre-processing, weighted frequency measure vector, representation vector generation) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as a historical incident dataset and/or a training dataset, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and/or aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

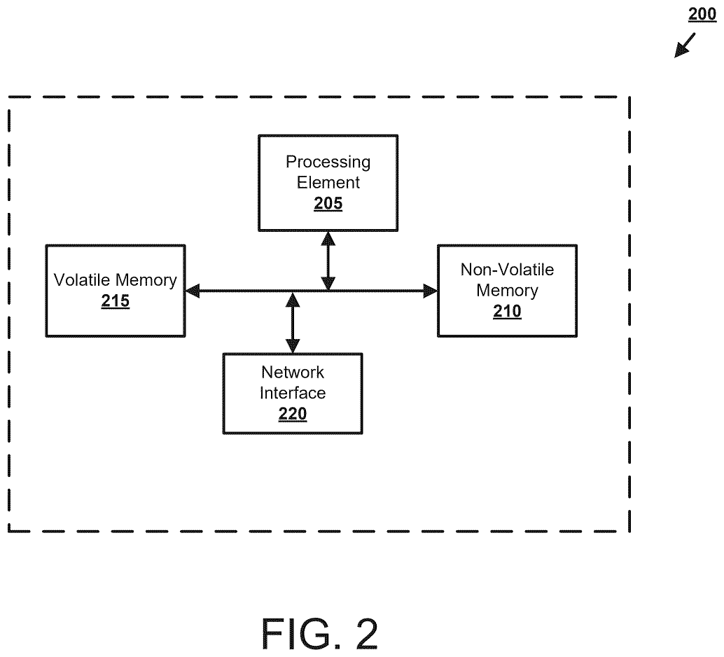

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilizes quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more components of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning tasks. By way of example, large language models (LLMs) and other transformer networks may be specially designed for operation within a quantum environment by replacing weight matrices in self-attention and/or multi-layer perceptron layers of such models with one or more combinations of variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entities 102, external computing entities 108), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

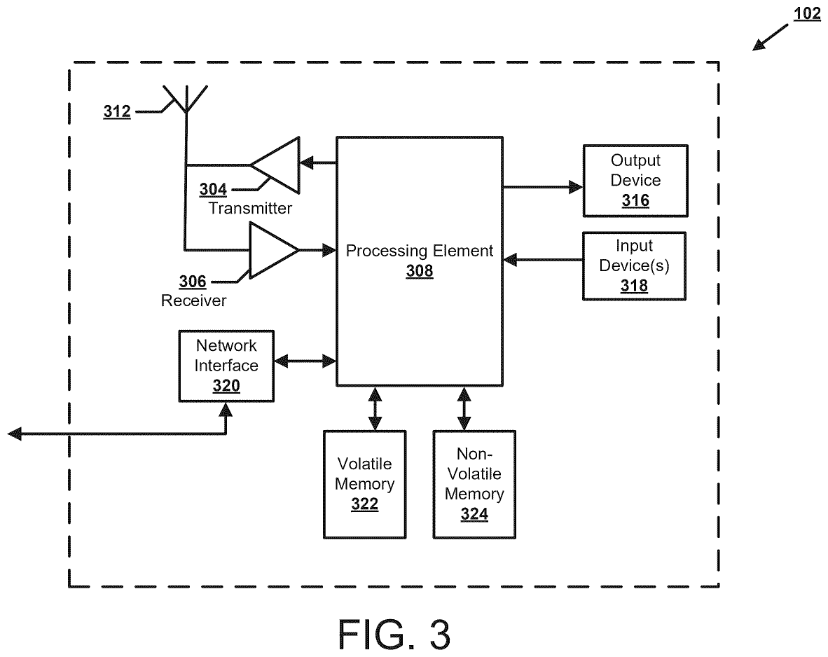

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to machine learning for NLP. In particular, systems and methods are disclosed herein that improve natural language understanding (NLU) of plain and/or unstructured natural language descriptions. The machine learning and data feature engineering techniques of the present disclosure enable improved data feature engineering (e.g., data extraction, compression, and/or embedding) of plain and/or unstructured natural language text data and thereby provide improved classification/prediction thereof. This, in turn, may improve the functionality of machine learning technologies used in chatbot and/or web interface applications for providing artificial intelligence-based detection and/or troubleshooting of issues that are more accurate and faster characterization, classification, and/or prediction based on plain and/or unstructured natural language descriptions (e.g., associated with one or more attributes).

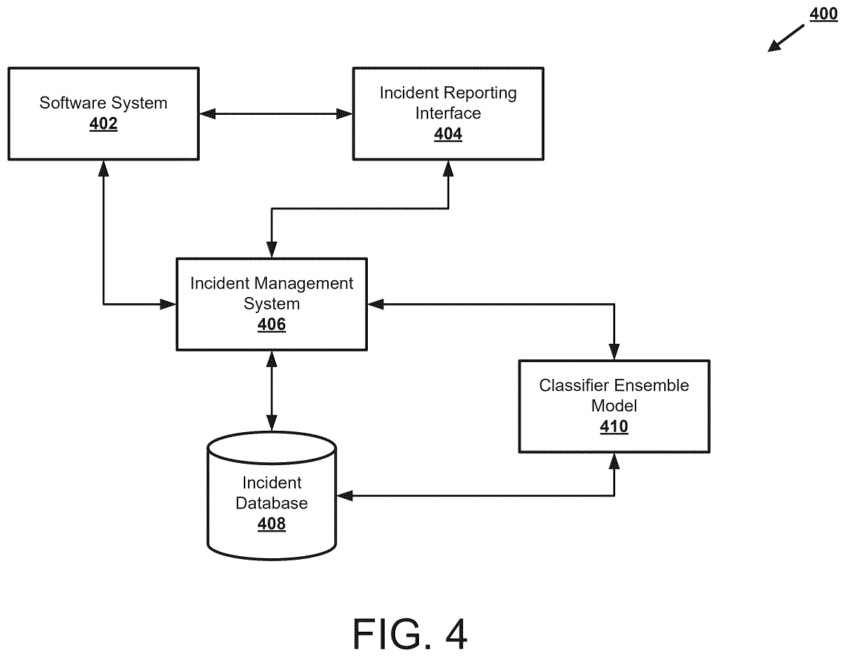

FIG. 4 depicts a dataflow diagram 400 showing example hardware and/or software components for processing and/or generating predictions for plain and/or unstructured natural language descriptions of software-related incidents in accordance with some embodiments of the present disclosure. The dataflow diagram 400, for example, illustrates a software support system architecture that is configured to provide incident reporting and/or troubleshooting with respect to a software system 402. Software system 402 is integrated and/or communicatively coupled with an incident reporting interface 404. The incident reporting interface 404 is configured to receive descriptions of incidents associated with software system 402 from a client computing device (e.g., client computing entities 102) and provide the descriptions as data objects to an incident management system 406. The incident management system 406 is configured to store the data objects to an incident database 408 in reference to the software system 402.

Data objects stored in incident database 408 may be representative of historical incidents and labeled with incident attributes to generate training data objects. A classifier ensemble model 410 may comprise a set of classification algorithms (e.g., of a set of machine learning classifier models) that are provided with and trained on training data objects to learn data features that respectively correspond to the incident attributes. The incident management system 406 is further configured to provide the classifier ensemble model 410 with unclassified data objects as inference input for generating, using the trained set of classification algorithms, inference output comprising classifications and/or predictions with respect to the incident attributes. The incident management system 406 is further configured to generate recommendations and/or perform prediction-based actions based on the inference output generated by the classifier ensemble model 410. In this way, the software support system architecture may provide machine learning-based software-related incident support and/or troubleshooting functionality that processes, learns, and applies machine learning for natural language understanding of plain and/or unstructured natural language descriptions comprising free-form data (e.g., text).

In some embodiments, the classifier ensemble model is previously trained by (i) receiving a training data object representative of a historical incident associated with the software system, (ii) generating a domain-enhanced training data object based on the training data object and the domain, (iii) generating an enhanced entity-level training vector for a pre-processed training entity from the domain-enhanced training data object by combining a training weighted frequency measure vector with an entity-level training vector for the pre-processed training entity, (iv) generating a training incident representation vector for the domain-enhanced training data object based on the enhanced entity-level training vector, and (v) providing the training incident representation vector to the classifier ensemble model, wherein the training data object comprises an incident attribute label that is used with the training incident representation vector to train the set of machine learning classifier models. In some embodiments, the training data object comprises a subset of incident attribute labels respectively corresponding to a subset of the set of machine learning classifier models, and the training data object is used to train the subset of the set of machine learning classifier models.

In some embodiments, an incident describes a problem, error, bug, or failure that occurs in a software system. An incident may disrupt or prevent a user's ability to use the software system as intended. For example, an incident may prevent a user from accessing data, cause programs to crash, and/or hinder communication within a software system. Incidents may be logged, recorded, and/or placed in a queue as data objects in a database of an incident management system for further review, analysis, classification, and/or remediation. In some embodiments, an incident management system implements a classifier ensemble model that is configured to categorize and prioritize incidents based on various attributes. Such attributes may comprise severity, priority, cause, affected software module, validity, and/or expected resolution time. Implementing a classifier ensemble model may comprise natural language processing techniques for converting unstructured incident descriptions into structured and/or formatted data that may be vectorized and processed by classification algorithms of the classifier ensemble model.

According to various embodiments, incidents may be described and/or reported by users. The incidents may be provided as user-provided plain and/or unstructured natural language input for bug tracking and/or quality assurance processes in software development and maintenance systems. By effectively managing and analyzing incidents, organizations may improve the stability and reliability of their software systems, reduce downtime, and/or enhance user experience.

In some embodiments, a data object describes a unit of data comprising text, images containing text, and/or audio. Data objects may serve as the fundamental units of information processed by an incident management system for classification performed by classification algorithms (e.g., of a set of machine learning classifier models of a classifier ensemble model). For example, a data object may be generated from information that is related to a specific incident, such as a description, and/or any associated media files from which information related to a specific incident may be extracted from. In some embodiments, data objects may be processed through a pipeline of operations, such as data augmentation, extraction, normalization, tokenization, feature engineering, and/or vectorization, to prepare the data for analysis by a machine learning model (e.g., a classifier ensemble model). In some embodiments, specialized storage and/or processing techniques may be employed on data objects comprising multimedia (e.g., images and/or audio) data objects, such as audio processing libraries for extracting text from speech.

In some embodiments, a training data object describes a data object comprising labeled information that is used to train a machine learning model, such as a machine learning classifier model or a classifier ensemble model comprising a set of machine learning classifier models. For example, a training data object may comprise a dataset that pairs data features (e.g., incident descriptions) with respectively corresponding labels (e.g., incident attribute labels). As such, a machine learning model trained with a training data object may learn relationships between features (e.g., incident description) and associated attributes and/or labels (e.g., severity, priority, cause). In the context of a classifier ensemble model, distinct training data objects may be used to train different machine learning classifier models of a set of machine learning classifier models. For example, separate training data objects may be generated for up to each incident attribute (severity, priority, cause, etc.) classification task, allowing specialized machine learning classifier models to be trained for up to each incident attribute classification task.

In some embodiments, a training data object may be generated by extracting historical incident data from a database of an incident management system. The labeling process for training data objects may be manual, automated, or a combination of both. For example, manual labeling may comprise domain experts reviewing historical incidents and assigning appropriate attributes. Automated labeling may leverage rule-based systems or classification models. In some embodiments, active learning techniques may be employed, where a machine learning model identifies ambiguous cases for human review, iteratively improving the quality of the training data. In some embodiments, a training data object may be domain-enhanced by processing the training data object through a domain rule engine and/or pre-processed via various natural language processing operations prior to input to a machine learning model.

In some embodiments, a software system describes a system comprising one or more processors and at least one memory that stores computer programmable code that, when executed by the one or more processors, causes the one or more processors to perform specific operations. The one or more processors may comprise CPUs, GPUs, and/or specialized processors, such as TPUs for machine learning operations. The at least one memory may comprise various types of computer-readable media, RAM, ROM, SSDs, and/or hard disk drives.

As described herewith, incidents may occur during operations performed by the software system that may disrupt or prevent a user's ability to use the software system as intended. In some embodiments, data ingestion components for capturing incidents, natural language processing modules for incident analysis, machine learning models for classification of incidents, databases for storing historical incidents, and user interfaces for interacting with an incident management system may be provided to support a software system.

In some embodiments, an unclassified data object describes a data object comprising free-form data where features of the data have not yet been classified or labeled. For example, an unclassified data object may comprise a description that is provided in a plain or unstructured language format, without explicit labels corresponding to specific incident attributes. An unclassified data object may comprise initial input that is provided to incident management systems and may be processed prior to input for a machine learning model to perform classification. In some embodiments, an unclassified data object may be domain-enhanced (e.g., generating a domain-enhanced data object) by processing the unclassified data object through a domain rule engine. Alternatively, or additionally, an unclassified data object may be pre-processed via various natural language processing operations. An unclassified data object may be further transformed into a vector-based representation that may be processed by classification algorithms.

In some embodiments, a historical incident describes an incident that has been resolved and/or previously addressed. For example, a historical incident may be representative of an incident that has been analyzed, classified, acted upon, and/or resolved. A historical incident may be further stored as a data structure in a database of an incident management system for subsequent retrieval (e.g., used for analysis and/or machine learning model training). A data structure for a historical incident may comprise data fields, such as incident description, classification label(s), resolution steps, and/or timestamps for various stages of an incident lifecycle.

In some embodiments, a historical incident may be used to train a machine learning model, such as a machine learning classifier model, to generate an ensemble model output. For example, a training data object based on a historical incident may comprise data that may be used to identify patterns, correlations, and/or trends that may inform the handling of new incidents.

In some embodiments, an incident attribute describes a data feature that is associated with a data object representative of an incident or comprising a description of an incident. An incident attribute may provide structured information about an aspect (e.g., of a plurality of aspects) of an incident and may be stored in a data object thereby enabling efficient categorization, prioritization, and management of the data object. In some embodiments, a data object may comprise fields or properties that are associated with incident attributes. Examples of incident attributes may comprise a severity attribute, a priority attribute, a cause attribute, a software module attribute, a validity attribute, or an age attribute, among others. The severity or priority attributes may be represented as integers or enumerated types. The cause and software module attributes may be represented as strings, characters, and/or keys referencing other tables/collections. The validity attribute may be represented by a Boolean value. The age attribute may be represented by an integer.

In some embodiments, incident attributes may be used as features in machine learning models for incident classification and prediction. In some embodiments, an incident attribute may be associated with a classification that is represented by an incident attribute label. In some embodiments, a data object may comprise description data (e.g., of an incident) and based on an analysis of the description data, one or more incident attribute labels may be assigned to the data object to classify the description data. For example, a machine learning classifier model may be trained with training data objects comprising incident attribute labels to predict incident attributes of new incidents (e.g., provided as unclassified data objects).

Accordingly, incident attributes may capture key information about up to each incident, enabling various artificial intelligence/machine-based system functionalities, such as classification, prioritization, routing, or reporting and analytics, among others. In some embodiments, by using a fixed set of attributes, an incident management system may be configured to ensure that all incidents are described using a same framework. In some embodiments, incident attributes may also allow for quick retrieval of relevant incidents. In some embodiments, changes in attribute values over time may be determined to identify emerging patterns or recurring issues. In some embodiments, incident attributes, such as priority and age, may be used to track compliance with service level agreements.

In some embodiments, a label describes a tag or identifier that classifies or emphasizes data features present in a data object (e.g., a vector). A label may be used in supervised machine learning tasks to provide the ground truth against which machine learning models are trained and evaluated. In some embodiments, labels may comprise categorical variables (e.g., incident attributes) that are represented as strings, integers, characters, enumerated types, and/or the like.

Labels may also serve as target variables that machine learning models, such as machine learning classifier models, aim to predict. That is, during training, a machine learning model may learn to associate patterns in training data features with respectively corresponding labels. For example, a training data object may comprise a label that is used by a machine learning classifier model to learn an association between data features (e.g., via a classification algorithm) in the training data object and the label. In turn, a trained machine learning classifier model may be configured to assign a label to an inference input (e.g., unclassified data object) when performing a classification task.

In some embodiments, a classifier ensemble model describes a machine learning model that comprises a set of machine learning classifier models that are combined to generate ensemble model output by aggregating and/or voting on a set of classification outputs generated by the set of machine learning classifier models. That is, a classifier ensemble model may be implemented as a higher-level object that manages a set of machine learning classifier models and implements an aggregation and/or voting logic. For example, a classifier ensemble model may combine individual classifications generated by the set of machine learning classifier models by using techniques, such as majority voting, weighted voting, or averaging of probabilities.

In some embodiments, the set of machine learning classifier models may comprise a plurality of machine learning classifier model subsets, where up to each machine learning classifier model subset is trained on a specific classification task. For example, a machine learning classifier model subset of a plurality of machine learning classifier model subsets may be trained to generate classifications for a respectively corresponding incident attribute of a plurality of incident attributes. As such, a classifier ensemble model may be configured to perform multi-label classification for a plurality of incident attributes based on a plurality of classification outputs generated by a plurality of machine learning classifier model subsets. That is, a classifier ensemble model may be configured to generate a plurality of outputs that respectively corresponds to a plurality of incident attributes.

In some embodiments, a machine learning classifier model subset may comprise a plurality of distinctive and/or independently trained machine learning classifier models. For example, a machine learning classifier model subset may comprise one or more of k-nearest neighbors (KNN), logistic regression, or support vector machine (SVM), among others. In some embodiments, up to each machine learning classifier model of a classifier ensemble model may be trained independently by using techniques, such as bagging or boosting to provide diversity or variance among a machine learning classifier model subset. In some embodiments, up to each machine learning classifier model of a classifier ensemble model may generate its own classification.

According to various embodiments, a classifier ensemble model may leverage the strengths of multiple individual machine learning classifier models by combining their classifications, effectively capturing different aspects of data and leading to a more robust and accurate model output compared to any single model alone. That is, up to each machine learning classifier model in the classifier ensemble model may focus on different patterns or features within data provided to the classifier ensemble model, which may result in a more comprehensive understanding of the data. For example, a classifier ensemble model may receive an incident representation vector as input and output predictions for multiple incident attributes. The classifier ensemble model architecture may capture different aspects based on specific types (e.g., incident attributes) of incidents and/or specific classifier algorithms.

In some embodiments, a classifier ensemble model's performance (e.g., accuracy of ensemble model output generated) may be improved by using techniques, such as stacking where a meta-model learns to combine classifications generated by a set of machine learning classifier models of the classifier ensemble model, or dynamic ensemble selection that selects classification outputs from specific members of the set of machine learning classifier models to generate an ensemble model output. In some embodiments, a classifier ensemble model may select classification outputs from specific members of the set (or subset) of machine learning classifier models to generate an ensemble model output based on evaluation metric scores determined for the set of machine learning classifier models. In some embodiments, a classifier ensemble model is configured to determine optimal weights (e.g., associated with weighted frequency measure vector) for incident representation vectors to reduce multinomial cross-entropy loss for classification.

In some embodiments, an ensemble model output describes an output that is generated by a classifier ensemble model. An ensemble model output may be generated based on a set of classification outputs that are generated by using a respectively corresponding set of machine learning classifier models. Generating an ensemble model output may comprise aggregating or combining the outputs from a set of individual machine learning classifier models. The aggregation or combination of outputs may be implemented in various ways, depending on the specific ensemble technique being used. Example techniques comprise majority voting, weighted averaging, or using a meta-classifier (stacking). As such, ensemble model outputs may be generated and used in a wide range of applications, particularly where high accuracy and robustness are valued. In the context of incident management systems, an ensemble model output might represent a final prediction about an incident's attributes, such as its severity, priority, or most appropriate handling team. Accordingly, an ensemble model output may be generated to triage processes, prioritize workloads, or provide decision support to human operators.

In some embodiments, an evaluation metric describes an assessment of machine learning model performance. Evaluation metrics may provide quantitative measures of how well a machine learning model is performing its intended operation, allowing for objective comparison between different machine learning models or iterations of a same machine learning model. An evaluation metric may comprise a function that receives as input, a classification or prediction generated by a machine learning model that is compared with a ground truth label, and outputs a numerical score. Examples of evaluation metrics may comprise precision, recall, accuracy, and/or the like.

In some embodiments, evaluation metrics may be used to guide hyperparameter tuning and/or machine learning model selection. For example, a classifier ensemble model may select and/or weight a set of machine learning classifier models for generating an ensemble model output based on evaluation metrics scoring of the machine learning classifier models.

In some embodiments, a machine learning classifier model describes to a machine learning model comprising a classification algorithm that is trained to generate a classification output based on a feature vector, such as an incident representation vector. A machine learning classifier model may be configured to assign predefined labels to inference input data (e.g., unclassified data objects) based on patterns learned from training examples. In some embodiments, a machine learning classifier model may be configured to generate a classification for a specific incident attribute, such as severity, priority, or root cause. For example, a machine learning classifier model may receive an incident representation vector as input and generate a classification for a specific incident attribute. A machine learning classifier model may comprise a classification algorithm, such as a KNN algorithm, an artificial neural network algorithm, a decision tree algorithm, a logistic regression algorithm, or a support vector machine algorithm, among others.

In some embodiments, a classification output describes a variable and/or value that is generated by a machine learning classifier model based on an inference input (e.g., unclassified data object). For example, a classification output may represent a machine learning classifier model's decision about a category or class to which the inference input belongs. In some embodiments, a classification output may be representative of a label that is assigned to an inference input by a classification algorithm of a machine learning classifier model. For example, a machine learning classifier model may be used to generate a classification output for an incident representation vector of an unclassified data object by assigning an incident attribute label to the incident representation vector. A classification output may comprise either a value that respectively corresponds to a label (e.g., multi-class classification) or a value that is representative of a model's confidence in a positive classification (e.g., binary classification).

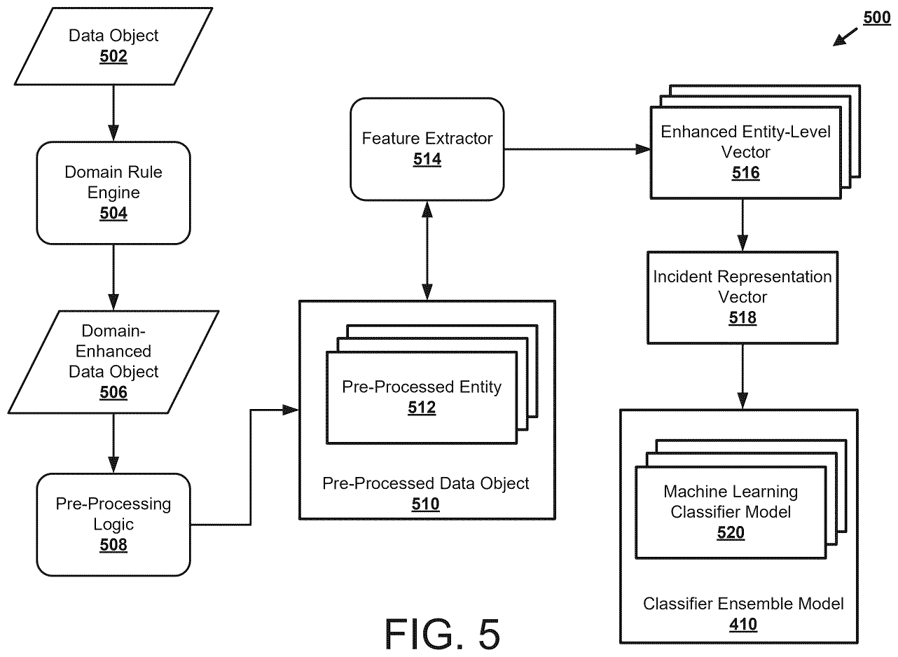

FIG. 5 depicts an operational example 500 of a data processing pipeline in accordance with some embodiments of the present disclosure. The operational example 500, for example, illustrates a multi-stage data engineering pipeline that is configured to processed and/or transform a data object 502 into an incident representation vector 518 that is provided (e.g., training data objects for training or unclassified data objects for inference) to a classifier ensemble model 410. As shown in the operational example 500, a data object 502 is provided to a domain rule engine 504. The domain rule engine 504 is configured to generate a domain-enhanced data object 506 by augmenting the data object 502 based on domain-specific rules. Pre-processing logic 508 is configured to generate a pre-processed data object 510 comprising one or more of pre-processed entity 512 by applying one or more NLP operations on the domain-enhanced data object 506.

A feature extractor 514 is configured to generate one or more of enhanced entity-level vector 516 for respectively corresponding one or more of pre-processed entity 512. The one or more of enhanced entity-level vector 516 are combined to generate an incident representation vector 518 that is provided to a classifier ensemble model 410. The classifier ensemble model 410 comprises a set of machine learning classifier model 520 that uses the incident representation vector 518 to (i) train (e.g., if the incident representation vector 518 is representative of a training data object) a set of classification algorithms associated with the set of machine learning classifier model 520 or (ii) generate (e.g., if the incident representation vector 518 is representative of an unclassified data object) an ensemble model output. In this way, the multi-stage data engineering pipeline may provide data feature enhancement of data objects that improves classification accuracy and/or performance of machine learning classifier models.

In some embodiments, an unclassified data object representative of an incident associated with the software system 402 is received. For example, text that is associated with an incident may be received from incident reporting interface 404. In some embodiments, the unclassified data object may comprise a description of a software-related incident, such as a production ticket description, a pre-production bug description, a functional bug, a non-functional bug, and/or the like. In some embodiments, the unclassified data object comprises text that is associated with different types of incidents that may be aggregated from various sources that are communicatively coupled to the software system 402 and/or the incident reporting interface to form a single dataset.

In some embodiments, a domain-enhanced data object is generated based on the unclassified data object and a domain that is associated with the software system 402.

In some embodiments, domain-enhanced describes a result of processing a data object (e.g., comprising text and/or images that comprise text) using a domain rule engine that explicitly treats specific words or abbreviations that have specific meaning within a context of a specific domain. That is, domain enhancement may comprise applying a set of rules or transformations, such as expanding acronyms, normalizing terminology, and/or identifying and tagging domain-specific entities (e.g., text and/or images comprising text) of a data object based on domain-specific knowledge (e.g., a knowledge base or ontology specific to a domain), which may be implemented as a graph database, a semantic network, or a set of rules encoded in a domain-specific language.

Domain enhancement may be particular useful in specialized fields, such as healthcare, finance, or specific areas of technology where general-purpose NLP operations may misinterpret or fail to recognize domain-specific terms. By applying domain-specific rules and knowledge, a system may accurately parse and understand text, leading to improved performance in downstream operations, such as feature extraction and/or classification. For example, in a healthcare domain, terms such as “BP” may be expanded to “blood pressure,” or medication names may be standardized to a common format. Accordingly, domain-enhancement may help bridge the gap between the natural language used by humans in a specific field and the structured/formatted data suitable for effective machine processing.

In some embodiments, a domain rule engine describes a software module comprising computer programmable code that identifies and/or provides special treatment of words or abbreviations that have special or specific meaning within a specific domain. In some embodiments, a domain rule engine may comprise a rule-based system and/or machine learning model that is/are configured to modify, tag, and/or process specific entities (e.g., text and/or images comprising text) of a data object. In some embodiments, a domain rule engine may utilize pattern matching algorithms, regular expressions, and/or decision trees to identify and/or process domain-specific terms. In some embodiments, a domain rule engine may employ machine learning models trained on domain-specific corpora to identify and correctly interpret domain-specific terminology.

In some embodiments, a domain rule engine may be used to generate a domain-enhanced data object from a data object. As such, a domain rule engine may improve the accuracy of text processing in specialized fields by aiding in correct interpretation of acronyms, jargon, and/or domain-specific phrases that may be misunderstood or overlooked by general-purpose NLP operations. A domain rule engine may enhance the quality of feature extraction from data objects (e.g., incident descriptions), leading to more accurate classification and analysis. Accordingly, domain-enhanced data object may be further processed via other NLP operations and/or vectorized prior to processing by a machine learning model.

As disclosed herewith, a domain rule engine may process a data object by applying a rule-based approach that identifies specific words or abbreviations that have specific meanings in a context of a specific domain and should be treated explicitly. For example, “IE” is not an English vocabulary word but may comprise an abbreviation of significance in the context of a specific domain. Additionally, “IE” may be expressed as “i.e.” in English sentences. Thus, usage and interpretation of “IE” may be significant and/or specific for a specific domain as it may be an abbreviation for “integrated eligibility” that is frequently used in the specific domain. As another example, “PATH” is an English language word with a specific meaning but may also refer to an abbreviated form of “People Access to Help” in a specific application, where either the abbreviated form or the full form may be used. Similarly, “People Access to Help” may be associated with four words that when used together may comprise a phrase that has a specific meaning to a specific domain. A domain rule engine may further subject words, phrases, acronyms, and/or the like to text pre-processing, spelling corrections, and/or root word extraction.

In some embodiments, a domain describes a specific field or context that affords special meaning to specific words or abbreviations. A domain may represent a particular area of knowledge, expertise, and/or activity that has its own specialized vocabulary, concepts, and conventions. Defining a domain may improve understanding and interpreting of text accurately in natural language processing and machine learning. That is, different domains may use the same words or phrases to define different things or may have unique terminologies that are not commonly used outside of specific domains. For example, the term “bug” in a software development domain may refer to a defect in code, while in a biology domain, it may refer to an insect.

A domain may be defined based on a structured knowledge base or ontology, which may be implemented using Web Ontology Language (OWL), comprising a formal representation of concepts, relationships, and/or rules within the domain. Alternatively, or additionally, domains may be encoded in specialized data structures or databases.

In some embodiments, a domain may provide a semantic framework for understanding and categorizing incidents by defining vocabulary, relationships, and rules that govern how different concepts within a field interact. For example, in a software development domain, terms such as “bug,” “feature,” “sprint,” or “deployment,” may have specific meanings and relationships that might not be apparent or relevant in other contexts. As such, enhancing a data object with respect to a domain may improve the performance of feature extraction algorithms, guide the creation of training datasets, and resolve model learning model interpretation for specialized applications. Thus, by explicitly providing domain knowledge, a machine learning model may achieve higher accuracy and generate more meaningful output when processing domain-specific text or data. This is particularly important in fields, such as healthcare, finance, or technical support, where misinterpretation of domain-specific terms may lead to significant errors or inefficiencies.

In some embodiments, an enhanced entity-level vector is generated for a pre-processed unclassified entity from the domain-enhanced data object by combining a weighted frequency measure vector with an entity-level vector for the pre-processed unclassified entity. In some embodiments, generating the enhanced entity-level vector comprises performing data feature extraction that transforms a data object (e.g., pre-processed data object 510) into a meaningful set of data features that is understandable to a machine learning model (e.g., machine learning classifier model 520 and/or classifier ensemble 410). In some embodiments, performing data feature extraction comprises (i) determining a weighted frequency measure vector for a pre-processed unclassified entity and (ii) generating one or more entity-level vectors from the pre-processed unclassified entity based on pre-trained language model, such as word2vec, and/or the like. The weighted frequency measure vector may be combined with the semantic feature to generate a representation vector (e.g., incident representation vector 518) that is usable in a classification process (e.g., associated with machine learning classifier model 520 and/or classifier ensemble model 410).

In some embodiments, generating the enhanced entity-level vector comprises (i) generating a set of pre-processed unclassified entities from the domain-enhanced data object and (ii) generating the incident representation vector by concatenating a set of enhanced entity-level vectors respectively corresponding to the set of pre-processed unclassified entities. In some embodiments, generating an enhanced entity-level vector comprises applying an NLP operation on the domain-enhanced data object, wherein the NLP operation comprises at least one of a normalization operation, a tokenization operation, a part-of-speech tagging operation, or a stemming operation. In some embodiments, the weighted frequency measure vector is generated by (i) generating a term frequency-inverse document frequency measure of the pre-processed unclassified entity, (ii) determining a part-of-speech (POS) tag for the pre-processed unclassified entity, and (iii) modifying the term frequency-inverse document frequency measure based on the POS tag. In some embodiments, the entity-level vector is generated by applying a language model to the pre-processed unclassified entity.

In some embodiments, the term “pre-processed” refers to a transformation that is associated with performing one or more NLP operations on a data object. For example, pre-processing via the performance of NLP operations may comprise a series of transformations that are applied to text data of a data object such that the text data may be provided in a form that is more suitable for further analysis or feature extraction for machine learning operations. In some embodiments, pre-processing may be performed to standardize data. For example, data objects comprising free-form text that is provided by users may be diverse and noisy. As such, pre-processing the data objects may help in reducing the dimensionality of features from data objects and remove irrelevant variations that may negatively impact the performance of downstream machine learning model processing. In some embodiments, NLP operations performed to pre-process data objects may be modified and/or fine-tuned based on one or more evaluation metrics determined for a machine learning model that is provided with pre-processed data objects as inputs.

In some embodiments, pre-processing may be performed on a data object prior to feature extraction and/or classification. In some embodiments, pre-processing comprises NLP operations, such as normalization, tokenization, part-of-speech tagging, and/or stemming to refine and prepare a data object for feature extraction and/or classification. In some embodiments, one or more NLP operations selected from a plurality of NLP operations are performed on a data object. For example, a first set of NLP operations may be performed on a data object to generate a first pre-processed data object for determining a weighted frequency measure vector for a first pre-processed unclassified entity of the first pre-processed data object. In another example, a second set of NLP operations may be performed on the data object to generate a second pre-processed data object for generating one or more entity-level vectors from a second pre-processed unclassified entity of the second pre-processed data object. In a specific example, a POS tagging operation and a stemming operation may be used determining a weighted frequency measure vector but not for generating one or more entity-level vectors. In some embodiments, the one or more NLP operations are selected from the plurality of NLP operations based on one or more evaluation metric determined for up to each of the machine learning classifier models 520. That is, based on the one or more evaluation metrics, specific ones of a plurality of NLP operations may be selected for either determining a weighted frequency measure vector or generating an entity-level vector. In some embodiments, an evaluation metric score is generated for a machine learning classifier model of the set of machine learning classifier models and the NLP operations are modified based on the evaluation metric score.

In some embodiments, a natural language processing (NLP) operation describes a text processing operation that formats, refines, and/or prepares text in a manner that is more suitable for a feature extraction process. In some embodiments, an NLP operation may comprise at least one of a normalization operation, a tokenization operation (e.g., breaking text into words or sub-words), a part-of-speech (POS) tagging operation (e.g., assigning grammatical categories to up to each word), and/or a stemming operation (e.g., removing common suffixes from words to produce a root word). In other embodiments, an NLP operation may comprise at least one of lowercasing, removal of punctuation and/or special characters, lemmatization (e.g., reducing words to their base or dictionary form), and/or removal of stop words (e.g., words that don't carry significant meaning). As such, NLP operations may bridge the gap between raw text input (e.g., a data object) and structured/formatted data suitable for machine learning models. For example, NLP operations may transform unstructured text (e.g., of an unclassified data object) into a more structured representation that captures important linguistic and semantic features. The output of NLP operations may be provided to a feature extraction process, which further transforms text into numerical vectors that may be processed by machine learning algorithms (e.g., of a set of machine learning classifier models of a classifier ensemble model).

In some embodiments, a normalization operation comprises removing unwanted data from a data object, such as punctuation marks, numbers, and/or non-English characters from text of a data object. In some embodiments, a normalization operation comprises converting words in text of a data object into lowercase letters. In some embodiments, a normalization operation comprises removing stop-words from text of a data object.

In some embodiments, a tokenization operation comprises splitting text of a data object into individual words based on whitespaces.

In some embodiments, a POS tagging operation comprises labeling words and/or tokens from text of a data object with syntactic classes that are associated with POS, such as noun, verb, adjective, and/or adverb.

In some embodiments, a stemming operation comprises removing prefixes and/or suffixes of words and/or tokens from text of a data object to generate root words. For example, after performing a stemming operation, “waits,” “waiting,” and “waited” may be reduced to “wait.

In some embodiments, an entity describes a data construct that is representative of an element from a data object. An entity may comprise a text element (e.g., word, term, phrase, and/or sequence of characters), bounding box within an image, and/or audio snippet, etc. An entity may comprise units of information that are extracted and processed in various NLP and feature extraction operations. A text element may comprise string objects or specialized data structures. A bounding box within an image may comprise arrays or objects. An audio snippet may comprise arrays of numerical values corresponding to an audio waveform. As described herewith, an entity may comprise a unit of analysis that is identified, determined, and/or extracted from a data object such that features within the data object may be decomposed into distinct attributes or indicators of attributes that may be individually analyzed. For example, in a data object comprising a description of an incident, entities may comprise specific words, software component names, and/or action verbs that describe a problem.

In some embodiments, an entity-level vector describes a numerical representation of an entity. An entity-level vector may capture semantic and syntactic information about an entity in a dense, numerical format, which allows for efficient computations, measurement of similarities between entities, clustering of related concepts, and/or performance of various classification and/or prediction tasks. An entity-level vector may be generated by converting (e.g., via vectorization or embedding) an entity from a data object into a vector (e.g., an array of floating-point numbers). Techniques for generating entity-level vectors may comprise word embeddings or contextual embeddings. For example, techniques, such as Word2Vec, GloVe, FastText, and/or the like, may be used to generate dense representation vectors of words based on their context in large text corpora. Word embeddings may comprise pre-trained embeddings that may be directly used or fine-tuned for specific operations. In another example, transformer models trained on large datasets using self-supervised learning techniques, such as bidirectional encoder representations from transformers (BERT) or generative pre-trained transformer (GPT), may be used to generate context-dependent representation vectors for words or sub-word tokens. According to various embodiments, entity-level vectors may be generated to transform textual descriptions of incidents into a format suitable for machine learning algorithms.

In some embodiments, an enhanced entity-level vector describes a numerical representation of an entity that is generated by combining a weighted frequency measure vector with an entity-level vector. As such, both semantic information and statistical relevance may be incorporated into a single representation vector. In some embodiments, a weighted frequency measure vector may be combined with an entity-level vector by element-wise multiplication or concatenation. Thus, an importance of an entity (e.g., word, phrase, term) may be incorporated into an entity-level vector along with semantic information.

An enhanced entity-level vector may capture not only the semantic meaning of an entity (e.g., word, phrase, term) but also the entity's importance or relevance within a specific context (e.g., a description of an incident). Accordingly, an enhanced entity-level vector may provide a richer representation of an entity for improved performance in operations, such as classification or similarity search. For example, the use of enhanced entity-level vectors may allow a machine learning algorithm (e.g., of a set of machine learning classifier models of a classifier ensemble model) to better distinguish between common and rare words, phrases, and/or terms, giving appropriate weight to domain-specific terminology that may be important for more accurate incident classification and/or prediction.

In some embodiments, a weighted frequency measure vector describes a value representative of an importance of an entity (e.g., a word) within a data object context (e.g., description). For example, a weighted frequency measure vector may assign words comprising certain attributes with more importance or weighting than others. In some embodiments, a weighted frequency measure vector comprises generating a weight value based on term frequency-inverse document frequency (TF-IDF) or variants thereof. For example, term frequency may be determined by counting occurrences of up to each term and inverse document frequency may be determined by determining a logarithm of a ratio of total documents (e.g., historical incidents) to the number of documents containing up to each term. In some embodiments, TF-IDF may be combined and/or modified based on a weighting scheme. For example, a weight may be applied to the TF-IDF based on entity attributes, such as part-of-speech tags.

Weighted frequency measure vectors may be used to emphasize and/or determine most relevant entities of a data object. As such, the use of weighted frequency measure vectors allows for more nuanced text analysis compared to, for example, simple word counting. For example, in a data object comprising a description of an incident, technical terms or error codes may be assigned higher weights than common English words. Thus, combining weighted frequency measure vector with an entity-level vector may lead to more accurate feature extraction and improved performance in downstream operations, such as incident classification, clustering, and/or similarity search.

In some embodiments, a weighted frequency measure vector comprises a modified TF-IDF-based measure. A TF-IDF-based measure may comprise a term frequency (TF) (e.g., a local term weight) and an inverse document frequency (IDF) (e.g., a global term weight), which may be calculated using the following formulas:

$$TF ( t , d ) = \frac{c ( t , d )}{{\sum }_{i} c ( {t}_{i} , d )} \qquad Equation \#1$$

where c(t, d) may represent the occurrence of term t appears in document d, and the denominator indicates the total number of terms in document d,

$$IDF ( t ) = 1 + log ( \frac{D}{{d}_{t}} ) \qquad Equation \#2$$

D may represent the total number of documents in the dataset, and de may represent the number of the documents a term t appeared in, and

$$TF - IDF ( t , d ) = TF ( t , d ) \cdot IDF ( t ) . \qquad Equation \#3$$

In some embodiments, the TF-IDF-based measure is modified based on POS. That is, certain POSs may be assigned higher weightings than other POSs in incident description classification. For example, verbs may be assigned a highest weight, followed by nouns and/or adjectives, while other POSs, such as prepositions and/or pronouns may be assigned to the lowest weights, as described in the below equation:

$${w}_{pos} ( t ) = \{ \begin{matrix}{w}_{1} & if t is verb \\ {w}_{2} & if t is noun or adjective \\ {w}_{3} & otherwise\end{matrix} \qquad Equation 4$$

where w₁>w₂>w₃>0, and the weights values for w₁, w₂, and w₃ are w₁=5, w₂=3 and w₃=1.

Accordingly, a TF based on POS may be expressed as:

$$TFPOS ( t , d ) = \frac{c ( t , d ) * {w}_{pos} ( t )}{{\sum }_{i} c ( {t}_{i} , d ) * {w}_{pos} ( {t}_{i} )} \qquad Equation 5$$

TFPOS-IDF(t, d) may be calculated for term t in document d by the following equation:

$$TFPOS - IDF ( t , d ) = TFPO S ( t , d ) \cdot IDF ( t ) , \qquad Equation 6$$

which may provide an output as a sparse matrix (e.g., high-dimensional vectors).

In some embodiments, an incident representation vector is generated for the domain-enhanced data object based on the enhanced entity-level vector.

In some embodiments, an incident representation vector describes a numerical representation of an incident. An incident representation vector may be generated based on one or more entity-level vectors that are associated with respectively corresponding one or more entities of a data object representative of a description of an incident. For example, one or more entities may be extracted from a data object by using one or more NLP operations. One or more entity-level vectors may then be generated based on the one or more entities. In some embodiments, an incident representation vector may be generated by combining the one or more entity-level vectors to form a single vector. Accordingly, a data object representative of a description of an incident may be converted into an incident representation vector for interpretation by a machine learning model, similarity comparison with other incident representation vectors (e.g., that are associated with historical incidents to identify incidents that are similar and/or related), and/or clustering via unsupervised learning techniques that may group similar incidents based on their representation vectors.

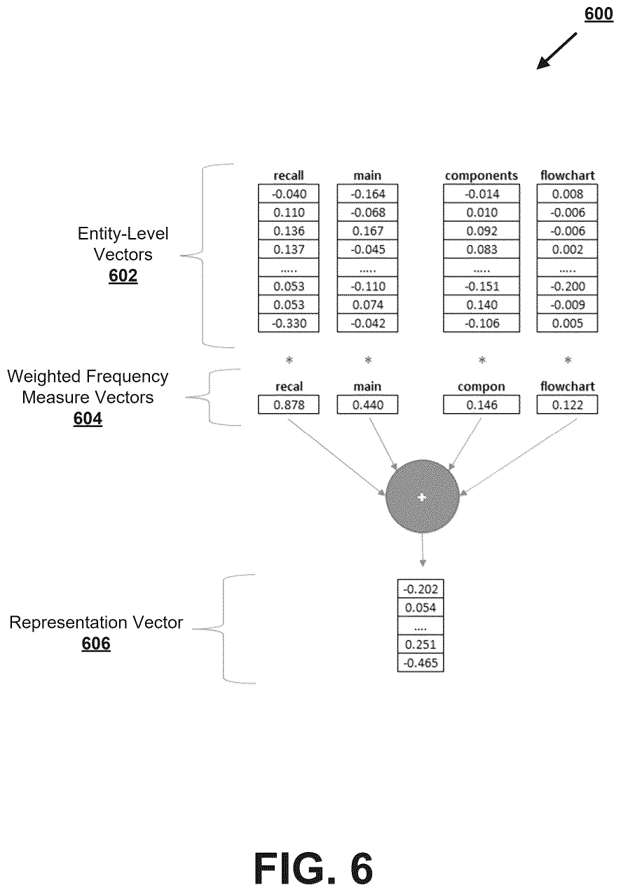

FIG. 6 depicts an operational example 600 of generating a representation vector 606 in accordance with some embodiments of the present disclosure. Entity-level vectors 602 are generated for a plurality of example entities comprising “recall,” “main,” “components,” and “flowchart” from a data object. Weighted frequency measure vectors 604 are also generated for the plurality of example entities. The entity-level vectors 602 are multiplied with the weighted frequency measure vectors 604 to generate respectively corresponding enhanced entity-level vectors that are combined (e.g., summed and/or concatenated) to generate a representation vector 606. As such, the representation vector 606 may be generated to represent an incident description with high-quality feature vectors. The representation vector 606 comprises a single vector that may be expressed as:

$$Representation Vector = {\sum }_{t ∈ d} Word 2 Vec ( t ) * [ TFPOS - IDF ( t , d ) ] \qquad Equation 7$$

where the term t belongs to the document d. Accordingly, the representation vector 606 may comprise a dense vector (e.g., low-dimensional) that is used to provide a respectively corresponding description to a machine learning model (e.g., the classifier ensemble model 410) for training or inference.

Referring back to FIG. 5, in some embodiments, the incident representation vector is provided as input to the classifier ensemble model 410 to receive a set of classification outputs that respectively corresponds to a set of incident attribute labels for the incident, wherein the classifier ensemble model 410 comprises a set of machine learning classifier models respectively configured to generate the set of classification outputs.

In some embodiments, the set of incident attribute labels comprises at least one of a severity attribute label, a priority attribute label, a cause attribute label, a software module attribute label, a validity attribute label, or an age attribute label. Accordingly, the set of classification outputs may comprise a predicted severity, a predicted priority, a predicted cause, a predicted software module (or impacted area), a predicted validity, and/or a predicted age (or time to resolve).

In some embodiments, the set of machine learning classifier models comprises (i) a first subset of models comprising a set of binary classification models and (ii) a second subset of models comprising a set of multi-classification models.

In some embodiments, the classifier ensemble model 410 is configured to determine, based on the incident representation vector, one or more historical incidents that are similar to an inference input comprising an incident description. In some embodiments, determining one or more historical incidents that are similar to an incident description comprises (i) determining a similarity score between the incident representation vector and a historical incident representation vector that is representative of a historical incident and (ii) generating an ensemble model output based on a plurality of incident attribute labels that are associated with the historical incident.

In some embodiments, the similarity score may comprise a cosine similarity score. As such, the classifier ensemble model 410 may generate a recommendation and/or prediction based on incident attribute labels assigned to historical incidents (and associated remediations) that are similar to the incident description.

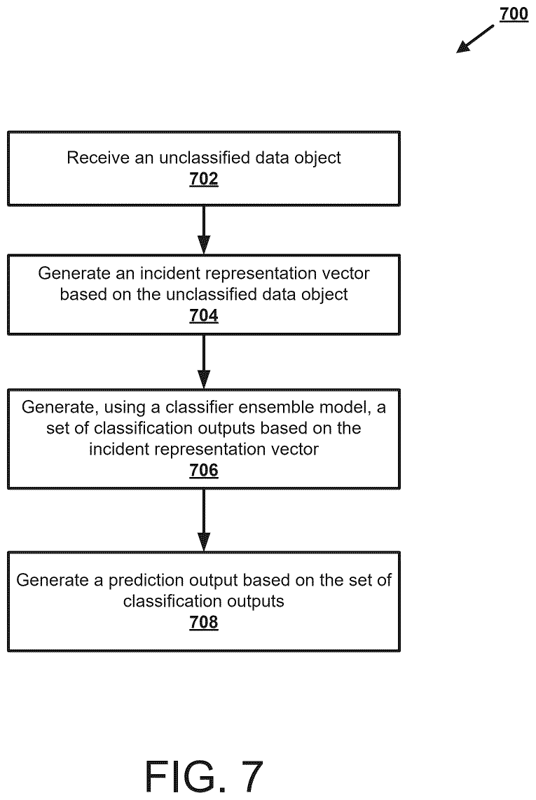

FIG. 7 depicts a flowchart diagram of an example machine learning inference process 700 in accordance with some embodiments of the present disclosure. The flowchart diagram depicts an example natural language understanding process for improved feature extraction and classification of plain and/or unstructured natural language descriptions. The process 700 may be implemented by one or more computing devices, entities, and/or systems described herein. For example, via the various steps/operations of the process 700, the computing system 101 may leverage data feature enhancement techniques that improve machine learning for NLP. By doing so, the process 700 improves NLU of plain and/or unstructured natural language descriptions.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving an unclassified data object representative of an incident associated with a software system. For example, the computing system 101 may receive an unclassified data object representative of an incident associated with a software system.

In some embodiments, the process 700 comprises, at operation 704, generating an incident representation vector based on the unclassified data object. For example, the computing system 101 may generate an incident representation vector based on the unclassified data object. In some embodiments, the unclassified data object comprises a domain-enhanced data object. In some embodiments, the unclassified data object comprises a pre-processed data object comprising one or more pre-processed entities. In some embodiments, the unclassified data object comprises one or more enhanced entity-level vectors that are generated from the one or more pre-processed entities.

In some embodiments, the process 700 comprises, at operation 706, generating, using a classifier ensemble model, a set of classification outputs based on the incident representation vector. For example, the computing system 101 may generate, using a classifier ensemble model, a set of classification outputs based on the incident representation vector.

In some embodiments, the process 700 comprises, at operation 708, generating a prediction output based on the set of classification outputs. For example, the computing system 101 may generate a prediction output based on the set of classification outputs.

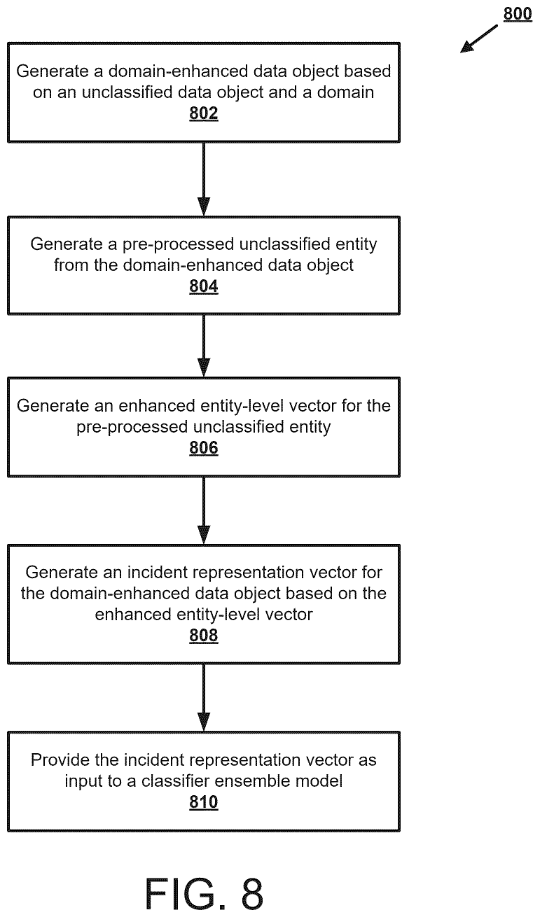

FIG. 8 depicts a flowchart diagram of an example data feature engineering process 800 in accordance with some embodiments of the present disclosure. The flowchart diagram depicts a data feature engineering technique for improving machine learning model understanding of plain and/or unstructured natural language description data. The process 800 may be implemented by one or more computing devices, entities, and/or systems described herein. For example, via the various steps/operations of the process 800, the computing system 101 may leverage an improved embedding technique for generating a representation vector of a data object comprising an incident description. By doing so, the process 800 generates improved classification of incident descriptions.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, generating a domain-enhanced data object based on an unclassified data object and a domain. For example, the computing system 101 may generate a domain-enhanced data object based on an unclassified data object and a domain. In some embodiments, the unclassified data object is representative of an incident associated with a software system. In some embodiments, the domain is associated with the software system.

In some embodiments, the process 800 comprises, at operation 804, generating a pre-processed unclassified entity from the domain-enhanced data object. For example, the computing system 101 may generate a pre-processed unclassified entity from the domain-enhanced data object.

In some embodiments, the process 800 comprises, at operation 806, generating an enhanced entity-level vector for the pre-processed unclassified entity from the domain-enhanced data object by combining a weighted frequency measure vector with an entity-level vector for the pre-processed unclassified entity. For example, the computing system 101 may generate an enhanced entity-level vector for the pre-processed unclassified entity from the domain-enhanced data object by combining a weighted frequency measure vector with an entity-level vector for the pre-processed unclassified entity.

In some embodiments, the process 800 comprises, at operation 808, generating an incident representation vector for the domain-enhanced data object based on the enhanced entity-level vector. For example, the computing system 101 may generate an incident representation vector for the domain-enhanced data object based on the enhanced entity-level vector.

In some embodiments, the process 800 comprises, at operation 810, providing the incident representation vector as input to a classifier ensemble model to receive a set of classification outputs that respectively corresponds to a set of incident attribute labels for the incident. For example, the computing system 101 may provide the incident representation vector as input to a classifier ensemble model to receive a set of classification outputs that respectively corresponds to a set of incident attribute labels for the incident. In some embodiments, the classifier ensemble model comprises a set of machine learning classifier models respectively configured to generate the set of classification outputs.

Some techniques of the present disclosure enable the generation of action outputs that may be performed to initiate one or more real world actions to achieve real-world effects. The techniques of the present disclosure may be used, applied, and/or otherwise leveraged to generate a diagnostic report, display/provide resources, generate, and/or execute action scripts, generate alerts or reminders, or generate one or more electronic communications based on a classification, prediction, and/or ensemble model output. In some examples, the classification, prediction, and/or ensemble model output of the present disclosure may trigger action outputs (e.g., through control instructions) to automate software system diagnostics, testing, patching, updating, and/or the like. The action outputs may control various aspects of a client device, such as the display, transmission, and/or the like of data reflective of an alert, and/or the like. The alert may be automatically communicated to an administrative user and/or may be used to initiate a software system update.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate an ensemble model output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.
Example 1. A computer-implemented method comprising: receiving, by one or more processors, an unclassified data object representative of an incident associated with a software system; generating, by the one or more processors, a domain-enhanced data object based on the unclassified data object and a domain that is associated with the software system; generating, by the one or more processors, an enhanced entity-level vector for a pre-processed unclassified entity from the domain-enhanced data object by combining a weighted frequency measure vector with an entity-level vector for the pre-processed unclassified entity; generating, by the one or more processors, an incident representation vector for the domain-enhanced data object based on the enhanced entity-level vector; and providing, by the one or more processors, the incident representation vector as input to a classifier ensemble model to receive a set of classification outputs that respectively corresponds to a set of incident attribute labels for the incident, wherein the classifier ensemble model comprises a set of machine learning classifier models respectively configured to generate the set of classification outputs.
Example 2. The computer-implemented method of example 1, wherein generating the enhanced entity-level vector comprises: generating a set of pre-processed unclassified entities from the domain-enhanced data object; and generating the incident representation vector by concatenating a set of enhanced entity-level vectors respectively corresponding to the set of pre-processed unclassified entities.
Example 3. The computer-implemented method of example 2, wherein generating an enhanced entity-level vector comprises applying a natural language processing (NLP) operation on the domain-enhanced data object, wherein the NLP operation comprises at least one of a normalization operation, a tokenization operation, a part-of-speech tagging operation, or a stemming operation.
Example 4. The computer-implemented method of example 3 further comprising: generating an evaluation metric score for a machine learning classifier model of the set of machine learning classifier models; and modifying the NLP operation based on the evaluation metric score.
Example 5. The computer-implemented method of example 1, wherein the weighted frequency measure vector is generated by: generating a term frequency-inverse document frequency measure of the pre-processed unclassified entity; determining a part-of-speech (POS) tag for the pre-processed unclassified entity; and modifying the term frequency-inverse document frequency measure based on the POS tag.
Example 6. The computer-implemented method of example 1, wherein the entity-level vector is generated by applying a language model to the pre-processed unclassified entity.
Example 7. The computer-implemented method of example 1, wherein the set of incident attribute labels comprises at least one of a severity attribute label, a priority attribute label, a cause attribute label, a software module attribute label, a validity attribute label, or an age attribute label.
Example 8. The computer-implemented method of example 1, wherein the classifier ensemble model is previously trained by: receiving a training data object representative of a historical incident associated with the software system; generating a domain-enhanced training data object based on the training data object and the domain; generating an enhanced entity-level training vector for a pre-processed training entity from the domain-enhanced training data object by combining a training weighted frequency measure vector with an entity-level training vector for the pre-processed training entity; generating a training incident representation vector for the domain-enhanced training data object based on the enhanced entity-level training vector; and providing the training incident representation vector to the classifier ensemble model, wherein the training data object comprises an incident attribute label that is used with the training incident representation vector to train the set of machine learning classifier models.
Example 9. The computer-implemented method of example 8, wherein the training data object comprises a subset of incident attribute labels respectively corresponding to a subset of the set of machine learning classifier models, and the training data object is used to train the subset of the set of machine learning classifier models.
Example 10. The computer-implemented method of example 1, wherein the set of machine learning classifier models comprises (i) a first subset of models comprising a set of binary classification models and (ii) a second subset of models comprising a set of multi-classification models.
Example 11. The computer-implemented method of example 1 further comprising: determining a similarity score between the incident representation vector and a historical incident representation vector that is representative of a historical incident; and generating an ensemble model output based on a plurality of incident attribute labels that are associated with the historical incident.
Example 12. A system comprising one or more processors and at least one memory storing processor-executable instructions that, when executed by any of the one or more processors, causes the one or more processors to perform operations comprising: receiving an unclassified data object representative of an incident associated with a software system; generating a domain-enhanced data object based on the unclassified data object and a domain that is associated with the software system; generating an enhanced entity-level vector for a pre-processed unclassified entity from the domain-enhanced data object by combining a weighted frequency measure vector with an entity-level vector for the pre-processed unclassified entity; generating an incident representation vector for the domain-enhanced data object based on the enhanced entity-level vector; and providing the incident representation vector as input to a classifier ensemble model to receive a set of classification outputs that respectively corresponds to a set of incident attribute labels for the incident, wherein the classifier ensemble model comprises a set of machine learning classifier models respectively configured to generate the set of classification outputs.
Example 13. The system of example 12, wherein to generate the enhanced entity-level vector, the operations further comprise: generating a set of pre-processed unclassified entities from the domain-enhanced data object; and generating the incident representation vector by concatenating a set of enhanced entity-level vectors respectively corresponding to the set of pre-processed unclassified entities.
Example 14. The system of example 13, wherein to generate an enhanced entity-level vector, the operations further comprise applying a natural language processing (NLP) operation on the domain-enhanced data object, wherein the NLP operation comprises at least one of a normalization operation, a tokenization operation, a part-of-speech tagging operation, or a stemming operation.
Example 15. The system of example 14, wherein the operations further comprise: generating an evaluation metric score for a machine learning classifier model of the set of machine learning classifier models; and modifying the NLP operation based on the evaluation metric score.
Example 16. The system of example 12, wherein to generate the weighted frequency measure vector, the operations further comprise: generating a term frequency-inverse document frequency measure of the pre-processed unclassified entity; determining a part-of-speech (POS) tag for the pre-processed unclassified entity; and modifying the term frequency-inverse document frequency measure based on the POS tag.
Example 17. One or more non-transitory computer-readable storage media including instructions that, when executed by one or more processors, cause the one or more processors to perform operations comprising: receiving an unclassified data object representative of an incident associated with a software system; generating a domain-enhanced data object based on the unclassified data object and a domain that is associated with the software system; generating an enhanced entity-level vector for a pre-processed unclassified entity from the domain-enhanced data object by combining a weighted frequency measure vector with an entity-level vector for the pre-processed unclassified entity; generating an incident representation vector for the domain-enhanced data object based on the enhanced entity-level vector; and providing the incident representation vector as input to a classifier ensemble model to receive a set of classification outputs that respectively corresponds to a set of incident attribute labels for the incident, wherein the classifier ensemble model comprises a set of machine learning classifier models respectively configured to generate the set of classification outputs.
Example 18. The one or more non-transitory computer-readable storage media of example 17, wherein to generate the enhanced entity-level vector, the operations further comprise: generating a set of pre-processed unclassified entities from the domain-enhanced data object; and generating the incident representation vector by concatenating a set of enhanced entity-level vectors respectively corresponding to the set of pre-processed unclassified entities.
Example 19. The one or more non-transitory computer-readable storage media of example 18, wherein to generate an enhanced entity-level vector, the operations further comprise applying a natural language processing (NLP) operation on the domain-enhanced data object, wherein the NLP operation comprises at least one of a normalization operation, a tokenization operation, a part-of-speech tagging operation, or a stemming operation.
Example 20. The one or more non-transitory computer-readable storage media of example 17, wherein to generate the weighted frequency measure vector, the operations further comprise: generating a term frequency-inverse document frequency measure of the pre-processed unclassified entity; determining a part-of-speech (POS) tag for the pre-processed unclassified entity; and modifying the term frequency-inverse document frequency measure based on the POS tag
Example 21. The computer-implemented method of example 1, wherein the method further comprises training the classifier ensemble model.
Example 22. The computer-implemented method of example 21, wherein the training is performed by the one or more processors.
Example 23. The computer-implemented method of example 21, wherein the one or more processors are comprised in a first computing entity; and the training is performed by one or more other processors comprised in a second computing entity.
Example 24. The system of example 12, wherein the operations further comprise training the classifier ensemble model.
Example 25. The system of example 24, wherein the one or more processors are comprised in a first computing entity; and the classifier ensemble model is trained by one or more other processors comprised in a second computing entity.
Example 26. The one or more non-transitory computer-readable storage media of example 17, wherein the operations further comprise training the classifier ensemble model.
Example 27. The one or more non-transitory computer-readable storage media of example 26, wherein the one or more processors are comprised in a first computing entity; and the classifier ensemble model is trained by one or more other processors comprised in a second computing entity.

1. A computer-implemented method comprising:
receiving, by one or more processors, an unclassified data object representative of an incident associated with a software system;
generating, by the one or more processors, a domain-enhanced data object based on the unclassified data object and a domain that is associated with the software system;
generating, by the one or more processors, an enhanced entity-level vector for a pre-processed unclassified entity from the domain-enhanced data object by combining a weighted frequency measure vector with an entity-level vector for the pre-processed unclassified entity;
generating, by the one or more processors, an incident representation vector for the domain-enhanced data object based on the enhanced entity-level vector; and
providing, by the one or more processors, the incident representation vector as input to a classifier ensemble model to receive a set of classification outputs that respectively corresponds to a set of incident attribute labels for the incident, wherein the classifier ensemble model comprises a set of machine learning classifier models respectively configured to generate the set of classification outputs.

2. The computer-implemented method of claim 1, wherein generating the enhanced entity-level vector comprises:
generating a set of pre-processed unclassified entities from the domain-enhanced data object; and
generating the incident representation vector by concatenating a set of enhanced entity-level vectors respectively corresponding to the set of pre-processed unclassified entities.

3. The computer-implemented method of claim 2, wherein generating an enhanced entity-level vector comprises applying a natural language processing (NLP) operation on the domain-enhanced data object, wherein the NLP operation comprises at least one of a normalization operation, a tokenization operation, a part-of-speech tagging operation, or a stemming operation.

4. The computer-implemented method of claim 3 further comprising:
generating an evaluation metric score for a machine learning classifier model of the set of machine learning classifier models; and
modifying the NLP operation based on the evaluation metric score.

5. The computer-implemented method of claim 1, wherein the weighted frequency measure vector is generated by:
generating a term frequency-inverse document frequency measure of the pre-processed unclassified entity;
determining a part-of-speech (POS) tag for the pre-processed unclassified entity; and
modifying the term frequency-inverse document frequency measure based on the POS tag.

6. The computer-implemented method of claim 1, wherein the entity-level vector is generated by applying a language model to the pre-processed unclassified entity.

7. The computer-implemented method of claim 1, wherein the set of incident attribute labels comprises at least one of a severity attribute label, a priority attribute label, a cause attribute label, a software module attribute label, a validity attribute label, or an age attribute label.

8. The computer-implemented method of claim 1, wherein the classifier ensemble model is previously trained by:
receiving a training data object representative of a historical incident associated with the software system;
generating a domain-enhanced training data object based on the training data object and the domain;
generating an enhanced entity-level training vector for a pre-processed training entity from the domain-enhanced training data object by combining a training weighted frequency measure vector with an entity-level training vector for the pre-processed training entity;
generating a training incident representation vector for the domain-enhanced training data object based on the enhanced entity-level training vector; and
providing the training incident representation vector to the classifier ensemble model, wherein the training data object comprises an incident attribute label that is used with the training incident representation vector to train the set of machine learning classifier models.

9. The computer-implemented method of claim 8, wherein the training data object comprises a subset of incident attribute labels respectively corresponding to a subset of the set of machine learning classifier models, and the training data object is used to train the subset of the set of machine learning classifier models.

10. The computer-implemented method of claim 1, wherein the set of machine learning classifier models comprises (i) a first subset of models comprising a set of binary classification models and (ii) a second subset of models comprising a set of multi-classification models.

11. The computer-implemented method of claim 1 further comprising:
determining a similarity score between the incident representation vector and a historical incident representation vector that is representative of a historical incident; and
generating an ensemble model output based on a plurality of incident attribute labels that are associated with the historical incident.

12. A system comprising
one or more processors and
at least one memory storing processor-executable instructions that, when executed by any of the one or more processors, causes the one or more processors to perform operations comprising:
receiving an unclassified data object representative of an incident associated with a software system;
generating a domain-enhanced data object based on the unclassified data object and a domain that is associated with the software system;
generating an enhanced entity-level vector for a pre-processed unclassified entity from the domain-enhanced data object by combining a weighted frequency measure vector with an entity-level vector for the pre-processed unclassified entity;
generating an incident representation vector for the domain-enhanced data object based on the enhanced entity-level vector; and
providing the incident representation vector as input to a classifier ensemble model to receive a set of classification outputs that respectively corresponds to a set of incident attribute labels for the incident, wherein the classifier ensemble model comprises a set of machine learning classifier models respectively configured to generate the set of classification outputs.

13. The system of claim 12, wherein to generate the enhanced entity-level vector, the operations further comprise:
generating a set of pre-processed unclassified entities from the domain-enhanced data object; and
generating the incident representation vector by concatenating a set of enhanced entity-level vectors respectively corresponding to the set of pre-processed unclassified entities.

14. The system of claim 13, wherein to generate an enhanced entity-level vector, the operations further comprise applying a natural language processing (NLP) operation on the domain-enhanced data object, wherein the NLP operation comprises at least one of a normalization operation, a tokenization operation, a part-of-speech tagging operation, or a stemming operation.

15. The system of claim 14, wherein the operations further comprise:
generating an evaluation metric score for a machine learning classifier model of the set of machine learning classifier models; and
modifying the NLP operation based on the evaluation metric score.

16. The system of claim 12, wherein to generate the weighted frequency measure vector, the operations further comprise:
generating a term frequency-inverse document frequency measure of the pre-processed unclassified entity;
determining a part-of-speech (POS) tag for the pre-processed unclassified entity; and
modifying the term frequency-inverse document frequency measure based on the POS tag.

17. One or more non-transitory computer-readable storage media including instructions that, when executed by one or more processors, cause the one or more processors to perform operations comprising:
receiving an unclassified data object representative of an incident associated with a software system;
generating a domain-enhanced data object based on the unclassified data object and a domain that is associated with the software system;
generating an enhanced entity-level vector for a pre-processed unclassified entity from the domain-enhanced data object by combining a weighted frequency measure vector with an entity-level vector for the pre-processed unclassified entity;
generating an incident representation vector for the domain-enhanced data object based on the enhanced entity-level vector; and
providing the incident representation vector as input to a classifier ensemble model to receive a set of classification outputs that respectively corresponds to a set of incident attribute labels for the incident, wherein the classifier ensemble model comprises a set of machine learning classifier models respectively configured to generate the set of classification outputs.

18. The one or more non-transitory computer-readable storage media of claim 17, wherein to generate the enhanced entity-level vector, the operations further comprise:
generating a set of pre-processed unclassified entities from the domain-enhanced data object; and
generating the incident representation vector by concatenating a set of enhanced entity-level vectors respectively corresponding to the set of pre-processed unclassified entities.

19. The one or more non-transitory computer-readable storage media of claim 18, wherein to generate an enhanced entity-level vector, the operations further comprise applying a natural language processing (NLP) operation on the domain-enhanced data object, wherein the NLP operation comprises at least one of a normalization operation, a tokenization operation, a part-of-speech tagging operation, or a stemming operation.

20. The one or more non-transitory computer-readable storage media of claim 17, wherein to generate the weighted frequency measure vector, the operations further comprise:
generating a term frequency-inverse document frequency measure of the pre-processed unclassified entity;
determining a part-of-speech (POS) tag for the pre-processed unclassified entity; and
modifying the term frequency-inverse document frequency measure based on the POS tag.
